(19) United States
(12) Patent Application Publication
(10) Pub. No.: US 2021/0217439 A1
(43) Pub. Date: Jul. 15, 2021

(54) ACOUSTIC EVENT RECOGNITION DEVICE, METHOD, AND PROGRAM

(71) Applicant: SONY CORPORATION, TOKYO (JP)

(72) Inventor: KAZUKI SHIMADA, TOKYO (JP)

(21) Appl. No.: 17/250,776

(22) PCT Filed: Aug. 28, 2019
(86) PCT No.: PCT/JP2019/033624

§ 371 Date: Mar. 2, 2021

(30) Foreign Application Priority Data
Sep. 11, 2018 (JP) 2018-169717

(51) Int. Cl. G10L 25/51; G10L 25/03; G06N 3/04; G06N 3/08

(52) U.S. Cl. CPC G10L 25/51; G06N 3/08; G06N 3/04; G10L 25/03

(57) ABSTRACT

The present technology relates to an acoustic event recognition device, method, and program that enable a recognition target to be added after the fact. The acoustic event recognition device includes a feature amount extraction unit that extracts a feature amount from input acoustic signals, an in-label recognition unit that recognizes whether or not the input acoustic signals of the feature amount indicate an acoustic event within a range of a label attached in advance and outputs a result of the recognition, a similarity/difference determination unit that determines a similarity/difference to/from an obtained acoustic event regardless of the label to output a determination result in a case where the in-label recognition unit fails to recognize an acoustic event, and a flag management unit that determines whether a flag corresponding to the acoustic event output from the in-label recognition unit or the similarity/difference determination unit is enabled and outputs the acoustic event as a recognition result in a case where the flag is enabled. The present technology is applicable to an acoustic event recognition device.

### TECHNICAL FIELD

The present technology relates to an acoustic event recognition device, method, and program, and in particular to an acoustic event recognition device, method, and program that enable a recognition target to be added after the fact.

### BACKGROUND ART

Conventionally, an acoustic event recognition system that recognizes an acoustic event on the basis of acoustic signals has been known.

For example, as techniques related to recognition of an acoustic event, there have been proposed techniques related to an acoustic event recognition system in which a recognition target is prepared in advance (e.g., see Patent Document 1) and a system for obtaining an unknown word from a dialog in voice recognition (e.g., see Patent Document 2).

### CITATION LIST

### Patent Document

Patent Document 1: Japanese Patent Application Laid-Open No. 2015-49398
Patent Document 2: Japanese Patent Application Laid-Open No. 2003-271180

### SUMMARY OF THE INVENTION

### Problems to be Solved by the Invention

However, in the technique described above, the recognition target is fixed in advance in the acoustic event recognition system, and it is not considered that the acoustic event recognition system adds a recognition target after the fact. That is, only a predetermined acoustic event is set as a recognition target.

Therefore, in such an acoustic event recognition system, an acoustic event presented by a user cannot be added as a recognition target after the fact. Furthermore, an acoustic event obtained by the acoustic event recognition system itself according to the environment also cannot be added as a recognition target after the fact.

For example, according to the technique disclosed in Patent Document 1, an acoustic event to be a recognition target is prepared in advance, whereby a recognition target cannot be added after the fact. Furthermore, while Patent Document 1 discloses an example of obtaining general sound data from a corpus in advance as a method of obtaining general sound data to be used for generating model data, it makes little mention of a general sound data acquisition unit related to design of a recognition target.

Moreover, according to the technique disclosed in Patent Document 2, an unknown acoustic category can be registered by obtaining an unknown word in a dialogue with a user and storing it in a storage. However, this is based on the assumption that registration of unknown words, that is, those that have linguistic information, is linked with voice recognition, no mention is made regarding an acoustic event having no linguistic information, and a recognition target cannot be added after the fact.

The present technology has been conceived in view of such a situation, and it is intended to enable a recognition target to be added after the fact.

### Solutions to Problems

An acoustic event recognition device according to one aspect of the present technology includes an acquisition unit that obtains, as a feature amount of a candidate for a new acoustic event, a feature amount of an acoustic signal presented by a user or a feature amount of an acoustic signal of an environmental sound, and a recognition unit that retains a parameter for recognizing a predetermined acoustic event, performs acoustic event recognition on the basis of the parameter and the obtained feature amount, and in a case where the predetermined acoustic event is not recognized, retains the obtained feature amount as the feature amount of the new acoustic event.

A method or program for recognizing an acoustic event according to one aspect of the present technology obtains, as a feature amount of a candidate for a new acoustic event, a feature amount of an acoustic signal presented by a user or a feature amount of an acoustic signal of an environmental sound, performs acoustic event recognition on the basis of a parameter for recognizing a predetermined acoustic event and the obtained feature amount, and retains the obtained feature amount as the feature amount of the new acoustic event in a case where the predetermined acoustic event is not recognized.

According to one aspect of the present technology, as a feature amount of a candidate for a new acoustic event, a feature amount of an acoustic signal presented by a user or a feature amount of an acoustic signal of an environmental sound is obtained, acoustic event recognition is performed on the basis of a parameter for recognizing a predetermined acoustic event and the obtained feature amount, and the obtained feature amount is retained as the feature amount of the new acoustic event in a case where the predetermined acoustic event is not recognized.

### BRIEF DESCRIPTION OF DRAWINGS

FIG. 1 is a diagram illustrating a transition of an operational mode.

FIG. 2 is a diagram illustrating an exemplary configuration of an acoustic event recognition device.

FIG. 3 is a diagram illustrating a range supported by a system.

FIG. 4 is a flowchart illustrating a process for obtaining a feature amount based on presentation from a user.

FIG. 5 is a flowchart illustrating a process for obtaining a feature amount based on acquisition by the system.

FIG. 6 is a diagram illustrating mapping, clustering, and a selection of a cluster.

FIG. 7 is a flowchart illustrating a recognition target addition process.

FIG. 8 is a diagram illustrating an acoustic event corresponding to a feature amount and its addition process.

FIG. 9 is a flowchart illustrating a recognition process.

FIG. 10 is a diagram illustrating an exemplary configuration of the acoustic event recognition device.

FIG. 11 is a diagram illustrating an exemplary configuration of the acoustic event recognition device.

FIG. 12 is a diagram illustrating an exemplary configuration of the acoustic event recognition device.

FIG. 13 is a diagram illustrating an exemplary configuration of a robot system.

FIG. 14 is a diagram illustrating an exemplary configuration of a computer.

### MODE FOR CARRYING OUT THE INVENTION

Hereinafter, embodiments to which the present technology is applied will be described with reference to the accompanying drawings.

### First Embodiment

<Exemplary Configuration of Acoustic Event Recognition Device>

The present technology relates to an acoustic event recognition system capable of adding a recognition target after the fact.

Here, an acoustic event indicates an event having common acoustic characteristics such as environmental sounds and musical sounds, which include, for example, hand clapping, bells, whistles, footsteps, car engine sounds, birdcalls, and the like. Furthermore, acoustic event recognition indicates to recognize a target acoustic event from recorded acoustic signals.

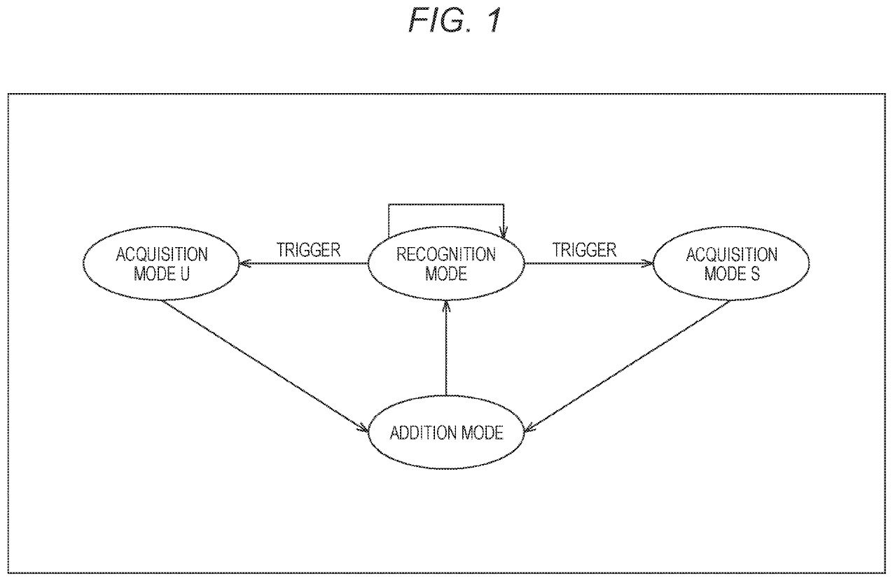

In the present technology, there are a recognition mode, an acquisition mode, and an addition mode as operational modes, for example, as illustrated in FIG. 1.

For example, when a system starts, the operational mode enters the recognition mode, and an acoustic event is recognized from input acoustic signals in the recognition mode.

In the recognition mode, a process of recognizing an acoustic event is continuously repeated unless there is a predetermined trigger such as an instruction for transition to the acquisition mode made by, for example, pressing of a button by a user or the like. Then, when the trigger occurs while the operational mode is the recognition mode, the operational mode transitions from the recognition mode to the acquisition mode.

In the acquisition mode, a feature amount (acoustic feature amount) of a certain section is obtained from the input acoustic signals. In particular, in the present example, the acquisition mode includes an acquisition mode U that obtains the feature amount from acoustic signals presented by the user, and an acquisition mode S that obtains the feature amount from acoustic signals obtained by the system.

Therefore, when a trigger for transition to the acquisition mode U occurs while the operational mode is the recognition mode, for example, the operational mode transitions from the recognition mode to the acquisition mode U.

Then, in the acquisition mode U, the feature amount is obtained from the acoustic signals presented by the user. When the feature amount is obtained in this manner, the operational mode transitions from the acquisition mode U to the addition mode thereafter without particularly requiring a trigger.

Meanwhile, when a trigger for transition to the acquisition mode S occurs while the operational mode is the recognition mode, the operational mode transitions from the recognition mode to the acquisition mode S.

Then, in the acquisition mode S, the feature amount is obtained from the acoustic signals obtained by the system. The acoustic signals obtained by the system referred to here indicate, for example, acoustic signals obtained by the system collecting ambient environmental sounds. When the feature amount is obtained in this manner, the operational mode transitions from the acquisition mode S to the addition mode thereafter without particularly requiring a trigger.

When the operational mode transitions from the acquisition mode U or the acquisition mode S to the addition mode, in the addition mode, the acoustic event corresponding to the feature amount obtained in the acquisition mode U or the acquisition mode S is added after the fact as a recognition target.

When the acoustic event to be a new recognition target is added after the fact in this manner, the operational mode transitions from the addition mode to the recognition mode thereafter without particularly requiring a trigger.

According to the present technology, the feature amount is obtained from the acoustic signals presented by the user in the acquisition mode U, whereby it becomes possible to make the system remember the acoustic event specified by the user as a recognition target after the fact in the addition mode.

Furthermore, the feature amount is obtained from the acoustic signals obtained by the system in the acquisition mode S, whereby the system can make the system itself remember the acoustic event according to the environment as a recognition target after the fact in the addition mode.

The acquisition mode S is especially useful in a case where, for example, it is difficult to know when an acoustic event occurs while it is known that the acoustic event occurs within a rather long period of time such as one day or one hour, a case where some processing is desired to be executed on an acoustic event that periodically occurs at a predetermined timing, and the like.

Note that, in a case where the acquisition mode U and the acquisition mode S are not particularly required to be distinguished from each other, they will be simply referred to as an acquisition mode in the following descriptions.

Next, an acoustic event recognition device that implements such an acoustic event recognition system will be described.

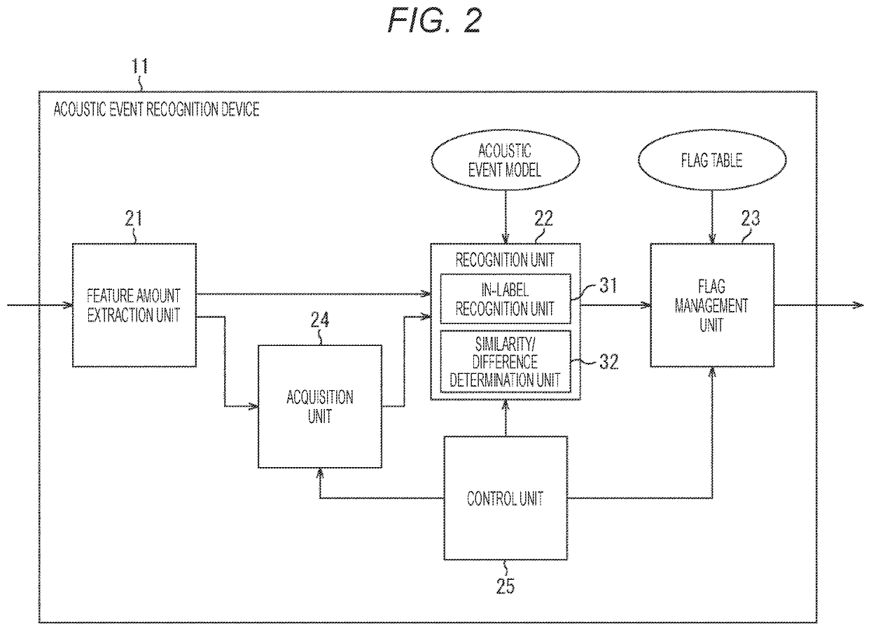

FIG. 2 is a diagram illustrating an exemplary configuration of the acoustic event recognition device to which the present technology is applied according to the embodiment.

An acoustic event recognition device 11 illustrated in FIG. 2 includes a feature amount extraction unit 21, a recognition unit 22, a flag management unit 23, an acquisition unit 24, and a control unit 25.

The feature amount extraction unit 21 extracts a feature amount from acoustic signals that are input of the system to supply it to the recognition unit 22 and the acquisition unit 24. For example, the feature amount extracted by the feature amount extraction unit 21 is supplied to the acquisition unit 24 when the operational mode is the acquisition mode, and is supplied to the recognition unit 22 when the operational mode is the recognition mode.

The recognition unit 22 recognizes the acoustic event on the basis of the supplied acoustic event model and the feature amount supplied from the feature amount extraction unit 21. In other words, the recognition unit 22 refers to the acoustic event model and outputs an acoustic event recognition result from the feature amount.

Here, the acoustic event model is information indicating the correspondence between the feature amount and the acoustic event, and includes various parameters obtained by prior learning or the like such as a function, a coefficient, and a feature amount, for example.

The recognition unit 22 includes an in-label recognition unit 31 that recognizes an acoustic event within a range of a label attached in advance, and a similarity/difference determination unit 32 that determines a similarity/difference to/from an obtained acoustic event regardless of the label.

The in-label recognition unit 31 retains an acoustic event model obtained by learning in advance and supplied at an optional timing, that is, parameters included in the acoustic event model.

The in-label recognition unit 31 recognizes an acoustic event within the range of the label attached in advance on the basis of the retained acoustic event model and the supplied feature amount.

Here, the acoustic event within the range of the label attached in advance indicates an acoustic event to be recognized by the acoustic event model, which is indicated by learning data to which the label of correct answer data is added at the time of learning the acoustic event model.

Therefore, in acoustic event recognition using the acoustic event model, whether the supplied feature amount corresponds to any of predetermined one or a plurality of acoustic events or does not correspond to any of them is obtained as an acoustic event recognition result. In other words, in the acoustic event recognition using the acoustic event model, a predetermined acoustic event is recognized.

For example, in a case where the acoustic event model, that is, the in-label recognition unit 31 includes a convolutional neural network (CNN) or the like, the in-label recognition unit 31 performs an operation by substituting the feature amount into the acoustic event model (CNN), thereby obtaining an acoustic event recognition result as output of the operation.

The similarity/difference determination unit 32 includes an acoustic model such as a Siamese network generated by metric learning, for example, and retains a feature amount of an acoustic event outside the label range obtained in the acquisition mode as a feature amount of the acoustic event added after the fact.

In the recognition mode, the similarity/difference determination unit 32 determines similarity/difference between the feature amount of optional acoustic signals supplied from the feature amount extraction unit 21 and the retained feature amount, thereby determining whether or not the acoustic event corresponding to the supplied feature amount is an acoustic event added after the fact.

Specifically, in a case where the similarity/difference determination unit 32 includes the Siamese network, for example, the similarity/difference determination unit 32 uses the supplied feature amount and the retained feature amount as input of the Siamese network, and maps those feature amounts in feature space.

Then, the similarity/difference determination unit 32 calculates a distance between those feature amounts in the feature space, and performs threshold processing on the obtained distance, thereby performing similarity/difference determination. For example, in a case where the obtained distance is equal to or less than a predetermined threshold value, the acoustic event corresponding to the supplied feature amount is determined to be the acoustic event corresponding to the retained feature amount, that is, the acoustic event added after the fact.

Note that, hereinafter, the acoustic event within the label range recognized by the in-label recognition unit 31 will also be referred to as an in-label acoustic event, and the acoustic event added after the fact recognized by the similarity/difference determination unit 32 will also be referred to as an additional acoustic event.

The recognition unit 22 outputs, to the flag management unit 23, a result of the acoustic event recognition performed by the in-label recognition unit 31 or a result of the similarity/difference determination performed by the similarity/difference determination unit 32 as an acoustic event recognition result in the recognition unit 22.

The flag management unit 23 manages a flag table. The flag table shows the correspondence between the acoustic event recognition result output by the recognition unit 22 and the acoustic event recognition result output by the system (acoustic event recognition device 11).

Specifically, the flag table includes flags generated for each in-label acoustic event and additional acoustic event. A flag of the acoustic event indicates whether or not to, when the recognition unit 22 recognizes an acoustic event, output an acoustic event recognition result indicating that the system (acoustic event recognition device 11) has recognized the acoustic event. In other words, a flag of the acoustic event is information indicating whether or not to output the acoustic event recognition result output by the recognition unit 22 as a final acoustic event recognition result of the system, that is, information indicating whether the output of the recognition unit 22 is enabled or disabled.

The flag management unit 23 manages the flag table, and outputs an acoustic event recognition result as a system (acoustic event recognition device 11) from the acoustic event recognition result output by the recognition unit 22.

Therefore, with a value of the flag of the acoustic event changed by the flag management unit 23, for example, a predetermined in-label acoustic event can be treated as if it were an acoustic event added after the fact. That is, the system (acoustic event recognition device 11) is enabled to act as if the predetermined in-label acoustic event were learned after the fact.

In the acquisition mode, the acquisition unit 24 obtains a feature amount of a certain section from the input acoustic signals, and supplies it to the recognition unit 22. That is, the acquisition unit 24 obtains the feature amount supplied from the feature amount extraction unit 21 in the acquisition mode as a candidate feature amount of an acoustic event to be added newly (after the fact) as a recognition target, and supplies it to the recognition unit 22.

Note that an example in which the acquisition unit 24 obtains the feature amount from the feature amount extraction unit 21 will be described here. However, it is not limited thereto, and the acquisition unit 24 may communicate with a cloud server or the like via a wired or wireless network to receive the feature amount from the server or the like, thereby obtaining the feature amount.

The control unit 25 controls the recognition unit 22, the flag management unit 23, and the acquisition unit 24.

In the acoustic event recognition device 11, the acquisition unit 24, the recognition unit 22, and the flag management unit 23 operate in an interlocked manner under the control of the control unit 25, whereby the acoustic event corresponding to the feature amount obtained in the acquisition mode is added as a recognition target so that the acoustic event can be recognized thereafter. That is, it becomes possible to make the system remember the acoustic event.

Specifically, with the acquisition unit 24 obtaining the feature amount from the feature amount extraction unit 21, the feature amount of the acoustic event to be added as a recognition target after the fact can be obtained. Furthermore, the similarity/difference determination unit 32 retains the feature amount of the additional acoustic event, and similarity/difference determination is carried out using the feature amount, whereby the acoustic event can be recognized even in the case of an acoustic event outside the label range.

With the acquisition unit 24 and the similarity/difference determination unit 32 provided in this manner, an acoustic event outside the label range can also be taken as a recognition target after the fact.

With the flag management unit 23 further provided, it becomes possible to adjust the output of the acoustic event recognition result by the recognition unit 22 and the output of the acoustic event recognition result as a system.

Therefore, for example, even in a case where the recognition unit 22 recognizes an acoustic event, the system can output an acoustic event recognition result as if the acoustic event were not recognized.

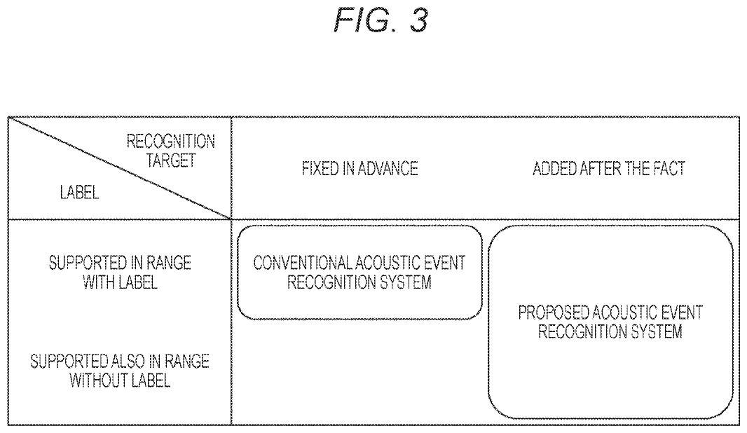

FIG. 3 illustrates the range supported by the system (acoustic event recognition device 11) proposed by the present applicant.

The present system (acoustic event recognition device 11) has an acquisition mode and an addition mode in addition to the recognition mode, and is capable of adding a recognition target after the fact.

The present system, that is, the acoustic event recognition device 11 includes the similarity/difference determination unit 32 in addition to the in-label recognition unit 31 and the flag management unit 23, and supports addition and recognition of an acoustic event outside the label range.

<Description of Feature Amount Acquisition Process>

Next, operation of the acoustic event recognition device 11 will be described.

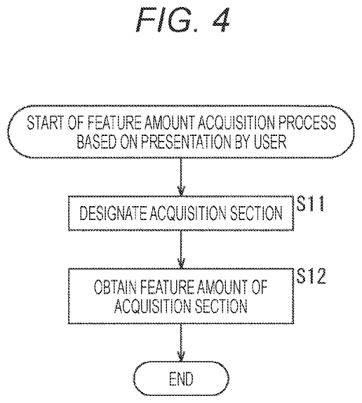

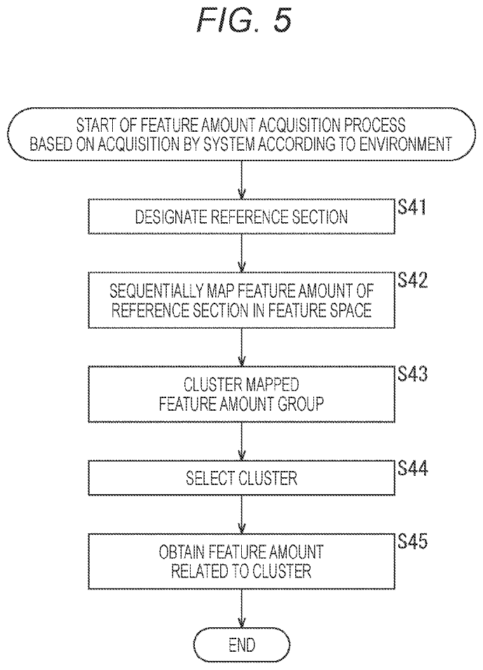

First, operation in the acquisition mode will be described with reference to FIGS. 4 and 5.

FIG. 4 illustrates a flowchart for explaining a feature amount acquisition process for obtaining a feature amount extracted from acoustic signals presented by the user in the acquisition mode U. Hereinafter, the feature amount acquisition process in a case where the user presents acoustic signals, which is performed by the acoustic event recognition device 11, will be described with reference to the flowchart of FIG. 4.

In step S11, the control unit 25 designates a feature amount acquisition section for the acquisition unit 24.

In step S12, the acquisition unit 24 obtains the feature amount of the acquisition section (designated section) designated by the control unit 25 in the processing of step S11 among the feature amounts supplied from the feature amount extraction unit 21, and supplies it to the recognition unit 22.

When the feature amount is obtained in this manner, the feature amount acquisition process is terminated. Note that the acoustic signals may be obtained as auxiliary information in addition to the feature amount.

As described above, the acoustic event recognition device 11 obtains the feature amount from the acoustic signals presented by the user in the acquisition mode U. With this arrangement, in the acquisition mode U, the system can be made to remember the acoustic event designated (presented) by the user as a recognition target.

Next, the feature amount acquisition process in a case where the acoustic event recognition device 11 (system) itself obtains the feature amount according to the environment in the acquisition mode S will be described with reference to the flowchart of FIG. 5.

In step S41, the control unit 25 designates a feature amount reference section for the acquisition unit 24. Here, the reference section indicates a section having a certain length, which is, for example, one day, one hour, or the like.

In the designated reference section, since the feature amount extraction unit 21 is sequentially supplied with sound around the acoustic event recognition device 11, that is, acoustic signals obtained by collecting ambient environmental sounds, the feature amount extraction unit 21 sequentially extracts a feature amount from the supplied acoustic signals and supplies it to the acquisition unit 24.

In step S42, the acquisition unit 24 sequentially maps, in the feature space, the feature amount of the reference section designated by the control unit 25 in the processing of step S41 among the feature amounts supplied from the feature amount extraction unit 21. For example, the entire reference section is divided into several continuous sections, and the feature amount obtained in each of those sections is mapped in the feature space.

In step S43, the acquisition unit 24 clusters the mapped feature amount groups.

In step S44, the acquisition unit 24 selects a predetermined cluster obtained by clustering.

In step S45, the acquisition unit 24 obtains the feature amount related to the cluster selected in step S44, and supplies it to the recognition unit 22. Specifically, for example, the acquisition unit 24 obtains a representative value such as the average value and the median value of a plurality of feature amounts belonging to the cluster selected in step S44, and supplies the representative value obtained in such a manner to the recognition unit 22 as a feature amount related to the cluster. Note that the acoustic signals may be obtained as auxiliary information in addition to the feature amount.

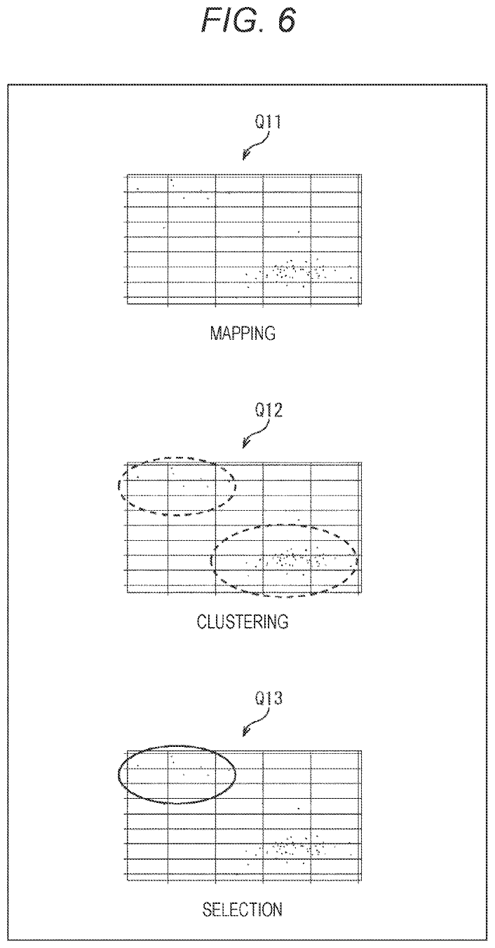

Here, FIG. 6 illustrates the concept of mapping, clustering, and cluster selection. That is, FIG. 6 illustrates a conceptual diagram of mapping, clustering, and cluster selection.

In particular, in FIG. 6, a part indicated by an arrow Q11 illustrates mapping of feature amounts in a feature space, a part indicated by an arrow Q12 illustrates exemplary clustering, and a part indicated by an arrow Q13 illustrates exemplary cluster selection.

While a two-dimensional feature space is illustrated in the part indicated by the arrow Q11, and each point in the feature space represents one feature amount obtained by the acquisition unit 24 and mapped in the feature space, the number of dimensions of the feature space may be any number. For example, Mel-frequency cepstrum coefficients (MFCC) can be considered as a feature space.

Furthermore, a part surrounded by a dotted line represents one cluster in the part indicated by the arrow Q12, and in this case, the feature amount group mapped in the feature space is clustered into two clusters. For example, k-means clustering can be considered as clustering.

Moreover, the part indicated by the arrow Q13 indicates that the cluster on the left side in the drawing is selected from the two clusters in the part indicated by the arrow Q12. Here, it is conceivable to select a cluster in which the number of elements included in the cluster is equal to or more than a first threshold value and equal to or less than a second threshold value as a method of selecting a cluster. When the cluster is selected in this manner, a representative value of the feature amounts belonging to the selected cluster is obtained, and the representative value is supplied to the recognition unit 22 as a feature amount related to the cluster.

Returning to the explanation of the flowchart of FIG. 5, when the acquisition unit 24 obtains the feature amount, the feature amount acquisition process is terminated.

As described above, the acoustic event recognition device 11 itself obtains the feature amount according to the environment in the acquisition mode S. With this arrangement, in the acquisition mode S, the system can make the system itself to remember the acoustic event according to the environment as a recognition target.

<Description of Recognition Target Addition Process>

Next, operation in the addition mode will be described.

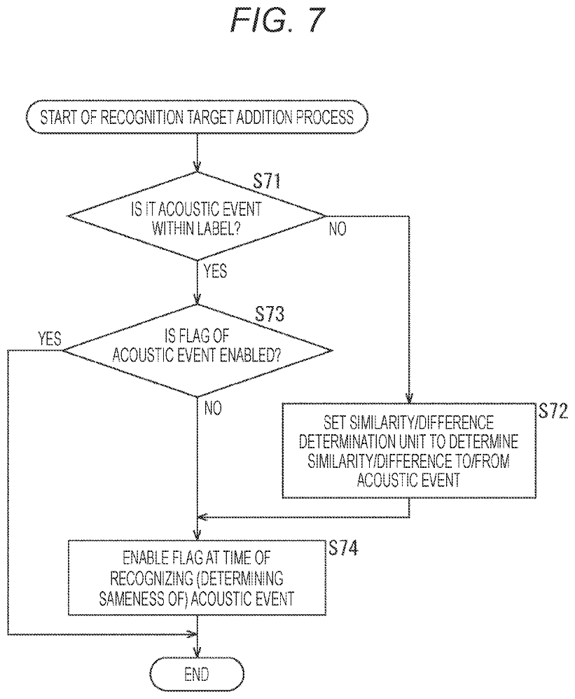

That is, hereinafter, a recognition target addition process performed by the acoustic event recognition device 11 will be described with reference to the flowchart of FIG. 7.

The recognition target addition process starts when the operational mode transitions to the addition mode after the feature amount is obtained in the acquisition mode U or the acquisition mode S. In the recognition target addition process, the acoustic event corresponding to the feature amount obtained by the feature amount acquisition process described with reference to FIGS. 4 and 5 is added as a recognition target.

In step S71, the in-label recognition unit 31 determines whether or not it is an acoustic event within the label. That is, the in-label recognition unit 31 recognizes the acoustic event on the basis of the feature amount supplied from the acquisition unit 24 in the acquisition mode and the acoustic event model retained in advance, and outputs an acoustic event recognition result obtained as a result thereof.

In a case where the in-label recognition unit 31 does not output an acoustic event recognition result, that is, in a case where an acoustic event recognition result indicating that the in-label acoustic event has not been recognized, it is determined not to be the acoustic event within the label in step S71, and the process proceeds to step S72.

In step S72, the similarity/difference determination unit 32 sets the similarity/difference determination unit 32 to determine a similarity/difference to/from the acoustic event, and then the process proceeds to step S74.

That is, in step S72, the similarity/difference determination unit 32 retains the feature amount supplied from the acquisition unit 24 in the acquisition mode as a feature amount of the additional acoustic event.

Specifically, for example, the similarity/difference determination unit 32 retains label information “Unknown 1” indicating a new additional acoustic event and the feature amount of the additional acoustic event in association with each other.

In step S74, the flag management unit 23 enables the flag at the time of recognizing the acoustic event, and the recognition target addition process is terminated.

For example, in a case where the label information “Unknown 1” indicating the new additional acoustic event and the feature amount are retained in association with each other in step S72, the flag management unit 23 generates a flag of the additional acoustic event indicated by the label information “Unknown 1”, and enables the flag. That is, the enabled flag of the additional acoustic event is added to the flag table.

On the other hand, in a case where the acoustic event is determined to be within the label in step S71, that is, in a case where there is output of an acoustic event recognition result, the in-label recognition unit 31 supplies the acoustic event recognition result to the flag management unit 23, and then the process proceeds to step S73.

In step S73, the flag management unit 23 determines, on the basis of the acoustic event recognition result supplied from the recognition unit 22, whether or not the flag of the acoustic event indicated by the acoustic event recognition result is enabled in the retained flag table.

In a case where the flag of the acoustic event is determined to be enabled in step S73, no particular processing is performed, and the recognition target addition process is terminated.

On the other hand, in a case where the flag of the acoustic event is determined not to be enabled in step S73, that is, in a case where the flag of the acoustic event corresponding to the acoustic event recognition result is disabled, the process proceeds to step S74.

In step S74, the flag management unit 23 enables the flag of the acoustic event determined not to be enabled in step S73 in the flag table, and the recognition target addition process is terminated.

As described above, the acoustic event recognition device 11 adds an acoustic event to be a recognition target as appropriate.

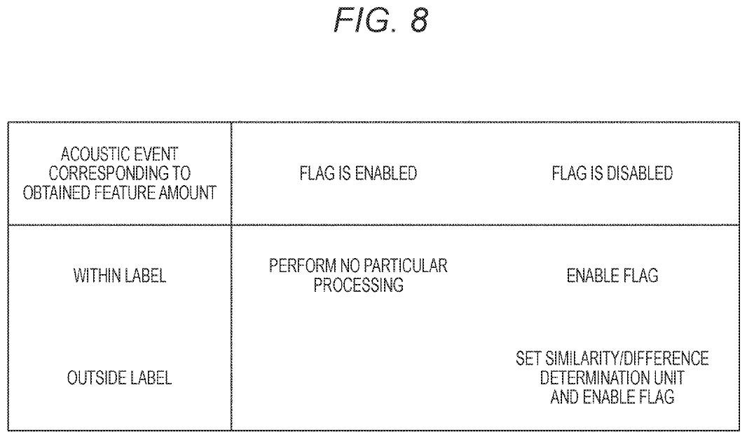

Here, FIG. 8 illustrates a table in which acoustic events corresponding to the obtained feature amount and their additional processing in the addition mode.

In this example, in a case where there is an output as an acoustic event recognition result within the label and the flag of the corresponding acoustic event is enabled, no particular processing is performed.

Furthermore, in a case where there is an output as an acoustic event recognition result within the label and the flag is disabled, the flag at the time of recognizing the corresponding acoustic event is enabled, and thereafter, it is treated in a similar manner to the recognition target prepared in advance.

In a case where there is no output of the acoustic event recognition result within the label, the similarity/difference determination unit 32 is set to determine a similarity/difference to/from the acoustic event to be added, the action flag at the time when it is determined to be the same as the acoustic event to be added is enabled, and thereafter, it is treated in a similar manner to the recognition target prepared in advance.

<Description of Recognition Process>

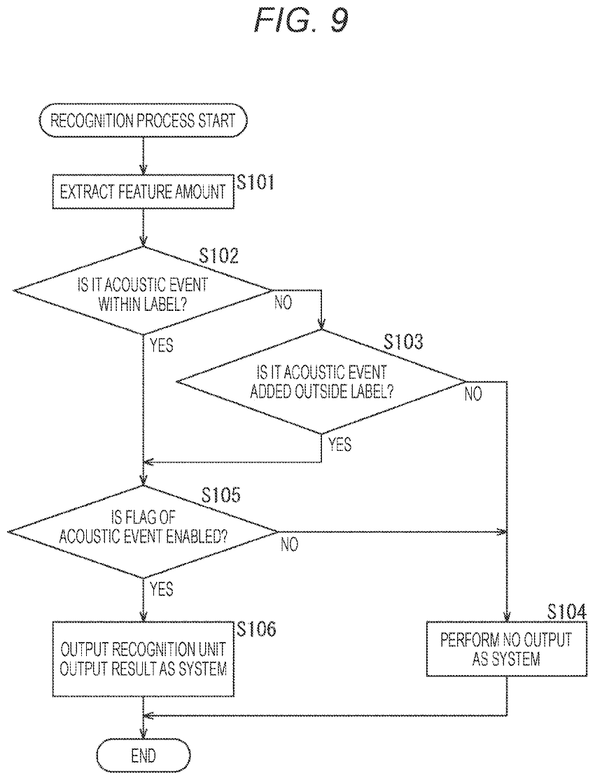

Moreover, operation in the recognition mode will be described with reference to FIG. 9. That is, hereinafter, a recognition process performed by the acoustic event recognition device 11 will be described with reference to the flowchart of FIG. 9.

In step S101, the feature amount extraction unit 21 extracts a feature amount from acoustic signals having been input (input acoustic signals), and supplies a result of the extraction to the recognition unit 22.

In step S102, the in-label recognition unit 31 of the recognition unit 22 performs acoustic event recognition of the in-label acoustic event on the basis of the feature amount supplied from the feature amount extraction unit 21 and the retained acoustic event model, and outputs a result of the acoustic event recognition, thereby determining whether or not the acoustic event corresponding to the supplied feature amount is an acoustic event within the label.

In a case where it is determined not to be the acoustic event within the label in step S102, in step S103, the similarity/difference determination unit 32 outputs the acoustic event recognition result on the basis of the feature amount, thereby determining whether or not it is an acoustic event added outside the label.

That is, the similarity/difference determination unit 32 performs acoustic event recognition (similarity/difference determination) of the additional acoustic event on the basis of the feature amount of the retained additional acoustic event and the feature amount supplied from the feature amount extraction unit 21, and outputs an acoustic event recognition result.

For example, in a case where the similarity/difference determination unit 32 does not output the acoustic event recognition result, that is, in a case where a recognition result indicating that the acoustic event corresponding to the supplied feature amount is not the additional acoustic event is obtained, it is determined not to be an acoustic event added outside the label.

Note that, in the recognition mode, the similarity/difference determination unit 32 may perform similarity/difference determination in a case where the in-label acoustic event is not recognized in the acoustic event recognition performed by the in-label recognition unit 31, or the acoustic event recognition by the in-label recognition unit 31 and the similarity/difference determination by the similarity/difference determination unit 32 may be carried out simultaneously (in parallel).

In a case where it is determined not to be an acoustic event added outside the label in step S103, the flag management unit 23 performs no output as a system (acoustic event recognition device 11) in step S104, and the recognition process is terminated.

On the other hand, in a case where it is determined to be an acoustic event added outside the label in step S103, the similarity/difference determination unit 32 outputs the acoustic event recognition result to the flag management unit 23, and then the process proceeds to step S105.

Furthermore, in a case where the acoustic event is determined to be within the label in step S102, the in-label recognition unit 31 outputs the acoustic event recognition result to the flag management unit 23, and then the process proceeds to step S105.

In a case where the acoustic event is determined to be within the label in step S102 or determined to be an acoustic event added outside the label in step S103, the processing of step S105 is performed.

In step S105, the flag management unit 23 determines whether or not the flag of the corresponding acoustic event is enabled on the basis of the acoustic event recognition result supplied from the recognition unit 22.

In a case where the flag of the acoustic event is determined not to be enabled in step S105, the flag management unit 23 performs no output as a system (acoustic event recognition device 11) in step S104, and the recognition process is terminated.

On the other hand, in a case where the flag of the acoustic event is determined to be enabled in step S105, the process proceeds to step S106 thereafter.

In step S106, the flag management unit 23 outputs, as a system (acoustic event recognition device 11), the corresponding acoustic event, that is, the output result of the recognition unit 22, and the recognition process is terminated.

As described above, the acoustic event recognition device 11 recognizes not only an acoustic event within the label but also an acoustic event added outside the label. With this arrangement, an acoustic event to be a recognition target can be added after the fact.

Note that, while the feature amount extraction unit 21 extracts a feature amount from acoustic signals that are input of the system, for example, the feature amount may be MFCC or a spectrogram.

Furthermore, the acoustic event model indicates the correspondence between the feature amount and the acoustic event, and for example, acoustic event models for an acoustic event E1 and so on are learned in advance and referred to by the in-label recognition unit 31. Furthermore, an acoustic event model for determining a similarity/difference to/from an optional acoustic event is learned in advance and referred to by the similarity/difference determination unit 32.

Moreover, the recognition unit 22 refers to the acoustic event model and outputs an acoustic event recognition result from the feature amount. The recognition unit 22 includes the in-label recognition unit 31 that recognizes an acoustic event within a range of a label attached in advance, and the similarity/difference determination unit 32 that determines a similarity/difference to/from an obtained acoustic event regardless of the label. For example, a convolutional neural network (CNN) can be considered as the in-label recognition unit 31. Furthermore, a Siamese network can be considered as the similarity/difference determination unit 32, for example.

### Variations of First Embodiment

<Exemplary Configuration of Acoustic Event Recognition Device>

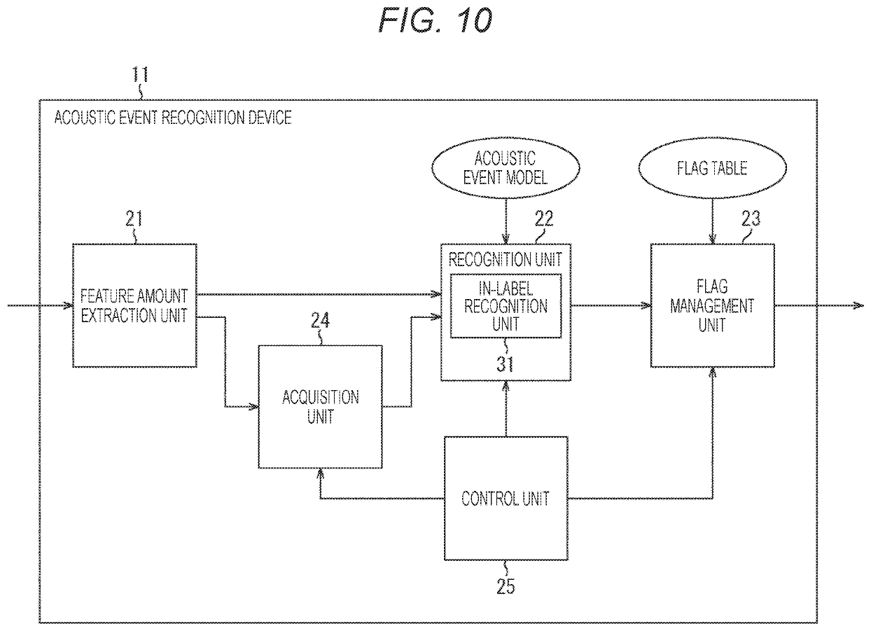

Furthermore, the acoustic event recognition device 11 is not limited to the configuration illustrated in FIG. 2, and may have a configuration illustrated in FIG. 10, 11, or 12, for example. Note that, in FIGS. 10 to 12, the parts corresponding to those in the case of FIG. 2 are denoted by the same reference signs, and descriptions thereof will be omitted as appropriate.

An acoustic event recognition device 11 illustrated in FIG. 10 includes a feature amount extraction unit 21, a recognition unit 22, a flag management unit 23, an acquisition unit 24, and a control unit 25. Furthermore, the recognition unit 22 includes an in-label recognition unit 31.

The configuration of the acoustic event recognition device 11 illustrated in FIG. 10 is different from the acoustic event recognition device 11 illustrated in FIG. 2 in that a similarity/difference determination unit 32 is not included, and except for that, it is a configuration same as that of the acoustic event recognition device 11 illustrated in FIG. 2.

Since the acoustic event recognition device 11 in FIG. 10 does not include the similarity/difference determination unit 32, it does not support addition and recognition of an acoustic event outside the label range.

However, since the flag management unit 23 is provided in this example, an in-label acoustic event with a disabled flag can be added as a recognition target in the addition mode. In this case, seen from the outside of the system, it appears as if the acoustic event were added as a recognition target after the fact.

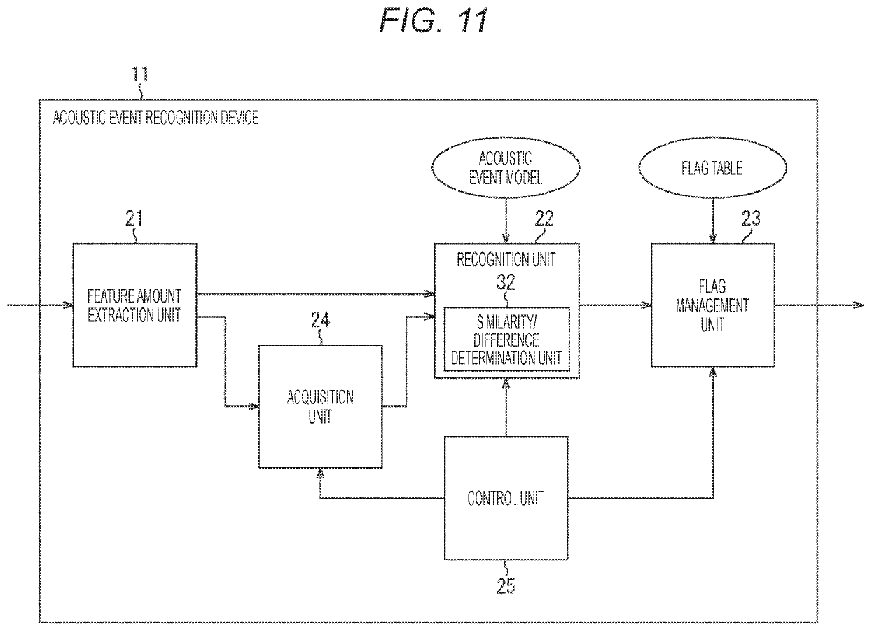

Furthermore, an acoustic event recognition device 11 illustrated in FIG. 11 includes a feature amount extraction unit 21, a recognition unit 22, a flag management unit 23, an acquisition unit 24, and a control unit 25. Furthermore, the recognition unit 22 includes a similarity/difference determination unit 32.

The configuration of the acoustic event recognition device 11 illustrated in FIG. 11 is different from the acoustic event recognition device 11 illustrated in FIG. 2 in that an in-label recognition unit 31 is not included, and except for that, it is a configuration same as that of the acoustic event recognition device 11 illustrated in FIG. 2.

While the acoustic event recognition device 11 of FIG. 11 is not capable of fixing an acoustic event to be a recognition target in advance as it does not include the in-label recognition unit 31, it is capable of adding an optional acoustic event as a recognition target after the fact.

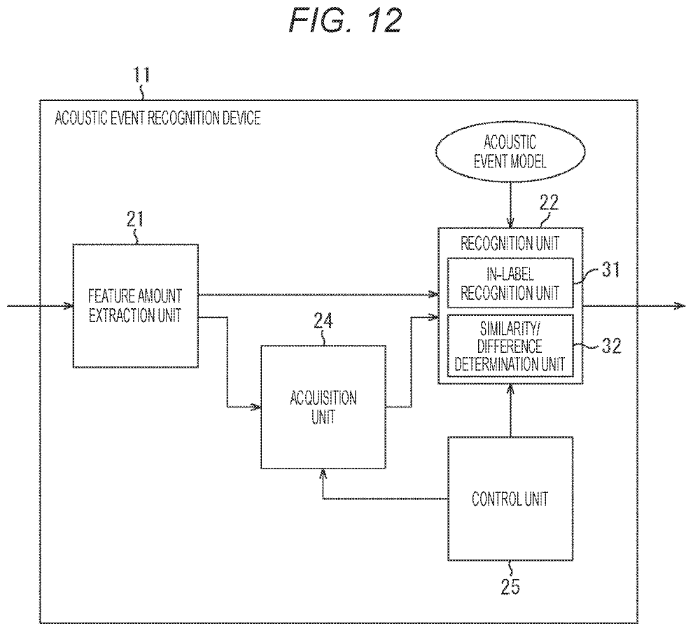

Moreover, an acoustic event recognition device 11 illustrated in FIG. 12 includes a feature amount extraction unit 21, a recognition unit 22, an acquisition unit 24, and a control unit 25. Furthermore, the recognition unit 22 includes an in-label recognition unit 31 and a similarity/difference determination unit 32.

The configuration of the acoustic event recognition device 11 illustrated in FIG. 12 is different from the acoustic event recognition device 11 illustrated in FIG. 2 in that a flag management unit 23 is not included, and except for that, it is a configuration same as that of the acoustic event recognition device 11 illustrated in FIG. 2.

While the acoustic event recognition device 11 of FIG. 12 is not capable of managing a flag of each acoustic event to be a recognition target as it does not include the flag management unit 23, it is capable of adding an optional acoustic event as a recognition target after the fact.

<Application Example of Present Technology>

Moreover, hereinafter, an exemplary case where an acoustic event recognition system to which the present technology is applied is installed in an autonomous robot will be described.

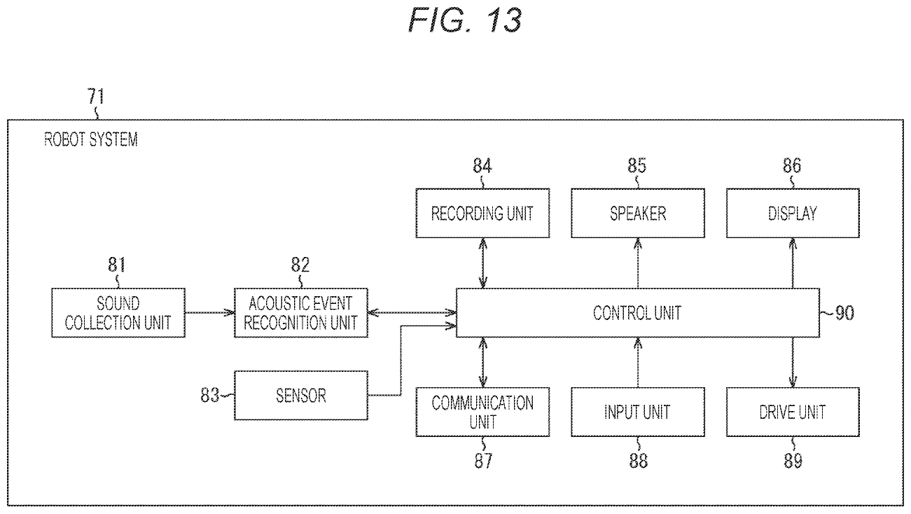

For example, a robot system to which the present technology is applied is configured as illustrated in FIG. 13.

A robot system 71 of FIG. 13 is installed in an autonomous robot or the like, for example, and includes a sound collection unit 81, an acoustic event recognition unit 82, a sensor 83, a recording unit 84, a speaker 85, a display 86, a communication unit 87, an input unit 88, a drive unit 89, and a control unit 90.

The sound collection unit 81 includes a microphone, which collects the sound around the robot system 71 and supplies acoustic signals obtained as a result thereof to the acoustic event recognition unit 82.

The acoustic event recognition unit 82 performs acoustic event recognition and the like on the acoustic signals supplied from the sound collection unit 81, and supplies the acoustic event recognition result and the acoustic signals to the control unit 90 as appropriate.

Note that the acoustic event recognition unit 82 has a configuration same as that of the acoustic event recognition device 11 illustrated in FIG. 2. That is, the acoustic event recognition unit 82 includes a feature amount extraction unit 21 to a flag management unit 23, and a recognition unit 22 of the acoustic event recognition unit 82 includes an in-label recognition unit 31 and a similarity/difference determination unit 32.

The sensor 83 includes, for example, a camera, a distance measuring sensor, and the like, and captures an image of the surroundings of the robot system 71 to supply it to the control unit 90, or measures a distance to an object around the robot system 71 to supply a result of the measurement to the control unit 90.

The recording unit 84, which records various data and programs, records data supplied from the control unit 90, and supplies the recorded data to the control unit 90.

The speaker 85 outputs sound on the basis of the acoustic signals supplied from the control unit 90. The display 86 includes, for example, a liquid crystal display panel and the like, and displays various images under the control of the control unit 90.

The communication unit 87, which communicates with a device such as a server (not illustrated) by wire or wirelessly, transmits data supplied from the control unit 90 to the server or the like, and supplies data received from the server or the like to the control unit 90.

The input unit 88 includes, for example, a button, a switch, and the like to be operated by a user, and supplies signals according to an operation made by the user to the control unit 90.

The drive unit 89 includes, for example, an actuator and the like, and is driven under the control of the control unit 90, thereby causing the autonomous robot or the like provided with the robot system 71 to perform an action such as walking. The control unit 90 controls operation of the entire robot system 71.

Next, a specific example of the operation of the autonomous robot equipped with such a robot system 71 will be described.

First, advance preparation of an acoustic event model, a flag table, and the like will be described.

It is assumed that an acoustic event model such as a CNN whose label range is acoustic events “hand clapping” and “bells” is learned in advance and retained in the in-label recognition unit 31. Furthermore, it is assumed that an acoustic event model such as a Siamese network, which is also applicable to the outside of the label range and determines a similarity/difference to/from a specified acoustic event, is learned in advance and retained in the similarity/difference determination unit 32.

For “hand clapping”, the flag is enabled (so that, in the flag table, a result output by the recognition unit 22 is to be a result output by the recognition system). The entire robot system 71 is set to cause the robot to run in a case where the recognition system outputs “hand clapping”.

For “bells”, the flag is disabled (so that, in the flag table, a result output by the recognition unit 22 is ignored and the recognition system performs no output). However, the entire robot system 71 is set to cause the robot to dance in a case where the recognition system outputs “bells”.

In a case where the recognition system outputs an acoustic event “Unknown 1”, which is outside the label range and is to be added after the fact, it is assumed that the entire robot system 71 is set to cause the robot to sing.

Next, operation after the entire robot system 71 including the recognition system is activated will be described.

“Run in Response to Hand Clapping”

When the robot system 71 is activated, the operational mode turns to the recognition mode, and the recognition process described with reference to FIG. 9 is repeated constantly during the recognition mode.

Furthermore, in the robot system 71, the sound collection unit 81 constantly collects ambient sound, and acoustic signals are subject to stream input to the feature amount extraction unit 21 of the acoustic event recognition unit 82. At this time, the feature amount extraction unit 21 sequentially extracts a feature amount from the acoustic signals.

While ordinary acoustic signals are being input, the recognition unit 22 performs no output, so that the recognition system, that is, the acoustic event recognition unit 82 performs no output.

When the user of the robot claps his/her hands around the robot, the feature amount is received, and the recognition unit 22, particularly the in-label recognition unit 31, outputs an acoustic event recognition result of “hand clapping”. Upon reception of the output, the flag management unit 23 refers to the flag table to confirm that the flag of “hand clapping” is enabled, and the acoustic event recognition result “hand clapping” is directly output as a recognition system.

Then, the control unit 90 that has received the supply of the acoustic event recognition result “hand clapping” drives the drive unit 89 in response to the acoustic event recognition result, and controls the robot to run.

At this time, even if a bell or a sound outside the label range is sounded, the recognition unit 22 does not output an acoustic event recognition result, so that the recognition system does not output the acoustic event recognition result to make the robot show no reaction.

“Present and Cause to Remember Bells, Dance upon Hearing Bells”

Furthermore, when the user presses a presentation addition button as the input unit 88, or the like, for example, the operational mode transitions from the recognition mode to the acquisition mode U (user presentation).

In the acquisition mode U, the user rings a bell in a specified section. The acquisition unit 24 obtains a feature amount of the acoustic event “bells” extracted from the acoustic signals in the section. Note that, in the acquisition mode U, the communication unit 87 may communicate with an external device to obtain a feature amount.

When the feature amount is obtained in the acquisition mode U, the operational mode transitions to the addition mode thereafter.

In the addition mode, the recognition target addition process described with reference to FIG. 7 is performed. At this time, the in-label recognition unit 31 outputs the acoustic event recognition result of “bells”. When the flag management unit 23 refers to the flag table, as the flag of the acoustic event “bells” is disabled, the flag management unit 23 enables the flag of the acoustic event “bells”.

When the recognition target addition process is performed in this manner, the operational mode transitions to the recognition mode thereafter.

In the recognition mode, the recognition process described with reference to FIG. 9 is repeatedly performed.

At this time, when the user rings a bell around the robot, the recognition unit 22 receives the feature amount, and the recognition unit 22, particularly the in-label recognition unit 31, outputs an acoustic event recognition result of “bells”. Upon reception of the output, the flag management unit 23 refers to the flag table to confirm that the flag of “bells” is enabled, and the acoustic event recognition result “bells” is directly output to the control unit 90 as a recognition system.

Then, the control unit 90 drives the drive unit 89 in response to the acoustic event recognition result “bells” to control the robot to dance.

At this time, even if a sound outside the label range is sounded, the recognition unit 22 does not output an acoustic event recognition result, so that the recognition system performs no output to make the robot show no reaction.

“Obtain and Remember a Whistle, Sing upon Hearing a Whistle”

Moreover, when the user operates the input unit 88 to instruct transition to the acquisition mode S while the operational mode is the recognition mode, for example, the operational mode transitions from the recognition mode to the acquisition mode S (system acquisition).

In the acquisition mode S, the acquisition unit 24 sequentially maps a feature amount in a feature space for a reference section specified by the control unit 25, which is, for example, for one day. At that time, a whistle blows in addition to regular noise in the reference section. After the reference section elapses, the mapped feature amount group is clustered. At that time, a cluster of regular noise and whistle clustering is formed. From among them, a cluster of whistles with the right number of elements is selected in accordance with criteria. The acquisition unit 24 obtains the feature amount related to the cluster. Note that, in the acquisition mode S, the communication unit 87 may communicate with an external device to obtain the feature amount.

After the reference section elapses, the operational mode transitions from the acquisition mode S to the addition mode.

In the addition mode, the recognition target addition process described with reference to FIG. 7 is performed. In this example, the in-label recognition unit 31 does not output an acoustic event recognition result. Therefore, the similarity/difference determination unit 32 is set such that the similarity/difference determination unit 32 determines a similarity/difference to/from the whistle acoustic event “Unknown 1”, and the flag at the time of recognizing “Unknown 1” is enabled. That is, the feature amount extracted from the acoustic signals of the whistle and the label information “Unknown 1” corresponding to the feature amount are associated with each other and retained in the similarity/difference determination unit 32.

When the recognition target addition process is terminated, the operational mode transitions from the acquisition mode S to the recognition mode, and the recognition process described with reference to FIG. 9 is repeatedly performed.

In this case, when a whistle blows around the robot, the recognition unit 22 receives a feature amount thereof. The in-label recognition unit 31 does not output an acoustic event recognition result. Meanwhile, the similarity/difference determination unit 32 outputs an acoustic event recognition result of “Unknown 1” that is a whistle. Upon reception of the output, the flag management unit 23 refers to the flag table to confirm that the flag of the acoustic event “Unknown 1” is enabled, and the acoustic event “Unknown 1” is directly output as a recognition system.

Then, the control unit 90 reads out acoustic signals of a predetermined piece of music or the like from the recording unit 84 according to the acoustic event recognition result of the acoustic event “Unknown 1” supplied from the flag management unit 23. Furthermore, the control unit 90 supplies the read acoustic signals to the speaker 85 to reproduce a piece of music or the like, thereby controlling the robot to sing.

At this time, even if a sound outside the label range other than the whistle is sounded, the recognition unit 22 does not output an acoustic event recognition result, so that the recognition system does not output the acoustic event recognition result to make the robot show no reaction.

In addition, the present technology described above may be as follows.

That is, for example, each process of the operational mode may be performed in parallel in a multi-process. Specifically, the recognition process described with reference to FIG. 9 may be constantly executed, for example, and in parallel with the recognition process, the feature amount acquisition process in the acquisition mode U described with reference to FIG. 4, the feature amount acquisition process in the acquisition mode S described with reference to FIG. 5, or the recognition target addition process described with reference to FIG. 7 may be performed as appropriate.

Furthermore, it is conceivable to feed back, from the outside of the acoustic event recognition system, whether or not to continuously recognize the added recognition target. For example, in a case where a stop command is received from the outside by the user pressing a button of an autonomous robot or the like, it is conceivable to disable the flag of the recognition target, for example.

For example, the control unit 90 controls the flag management unit 23 on the basis of the signals supplied from the input unit 88 in response to the operation made by the user, and disable the flag of the specified acoustic event.

Moreover, for example, it is conceivable to transmit the feature amount or the acoustic signals obtained at the time of adding the recognition target to the outside to use it as auxiliary information. For example, it is conceivable that, when a yelp of a dog is obtained, a feature amount thereof is transmitted to the outside and is reflected at the time of output, or the like.

Furthermore, for example, the flag management unit 23 may obtain acoustic signals of the yelp of the dog from the feature amount extraction unit 21 via the recognition unit 22 and the acquisition unit 24 to supply them to the control unit 90. In this case, the control unit 90 supplies the acoustic signals supplied from the flag management unit 23 to the speaker 85 so that the yelp of the dog is caused to reproduce. With this arrangement, the user can understand what kind of acoustic event has been added as a recognition target.

Moreover, for example, it is conceivable to enable a feature amount and acoustic signals automatically obtained by the system to be checked using an application or the like. Furthermore, it is also conceivable to allow the user to operate labels and flags. For example, it is conceivable that the user checks the feature amount and the acoustic signals of “Unknown 1” described above on a smartphone application to label the event as “whistle”, or the like.

Furthermore, in a case where the acoustic event “whistle” is newly added as a recognition target, for example, the control unit 90 obtains the label information “Unknown 1” of the acoustic event “whistle” from the recognition unit 22 via the flag management unit 23, and supplies it to the display 86 to be displayed.

At this time, as described above, the control unit 90 may supply the acoustic signals of the acoustic event “whistle” to the speaker 85 to cause it to reproduce the actual acoustic event “whistle” so that the user can directly check the actual sound.

Moreover, the user operates the input unit 88 after seeing the label information “Unknown 1” displayed on the display 86 or listening to the sound of the actual acoustic event “whistle” to make an instruction for changing the label information from “Unknown 1” to “whistle”. Then, the control unit 90 controls the flag management unit 23 according to the signals supplied from the input unit 88, and causes the label information of the acoustic event “whistle” in the flag management unit 23 and the similarity/difference determination unit 32 to be changed to “whistle”. Such a change of the label information may be achieved by the communication unit 87 communicating with a smartphone of the user and the user operating the smartphone.

As described above, according to the present technology, it becomes possible to cause an autonomous robot to remember an acoustic event that the user wants the robot to remember or an environment-specific acoustic event after the fact by, for example, installing a system to which the present technology is applied in the autonomous robot.

<Exemplary Configuration of Computer>

Meanwhile, the series of processing described above can be executed by hardware or by software. In a case where the series of processing is executed by software, a program included in the software is installed in a computer. Here, examples of the computer include a computer incorporated in dedicated hardware, a general-purpose personal computer capable of executing various functions by installing various programs, and the like.

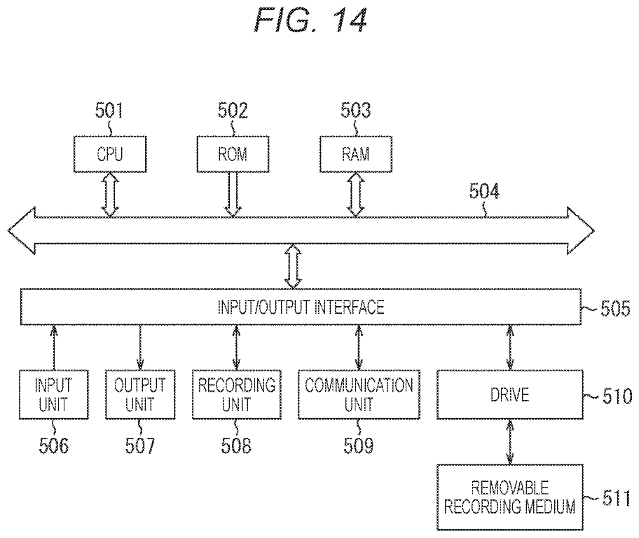

FIG. 14 is a block diagram illustrating an exemplary hardware configuration of a computer that executes, using a program, the series of processing described above.

In a computer, a central processing unit (CPU) 501, a read only memory (ROM) 502, and a random access memory (RAM) 503 are coupled to one another via a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, an image pickup device, and the like. The output unit 507 includes a display, a speaker, and the like. The recording unit 508 includes a hard disk, a non-volatile memory, and the like. The communication unit 509 includes a network interface, and the like. The drive 510 drives a removable recording medium 511 such as a magnetic disk, an optical disk, a magneto-optical disk, and a semiconductor memory.

In the computer configured as described above, for example, the CPU 501 loads the program stored in the recording unit 508 into the RAM 503 via the input/output interface 505 and the bus 504 and executes the program, thereby performing the series of processing described above.

The program to be executed by the computer (CPU 501) may be provided by, for example, being recorded in the removable recording medium 511 as a package medium or the like. Furthermore, the program may be provided through a wired or wireless transmission medium such as a local area network, the Internet, and digital satellite broadcasting.

In the computer, the program may be installed in the recording unit 508 via the input/output interface 505 by attaching the removable recording medium 511 to the drive 510. Furthermore, the program may be received by the communication unit 509 via a wired or wireless transmission medium and installed in the recording unit 508. In addition, the program may be installed in the ROM 502 or the recording unit 508 in advance.

Note that the program to be executed by the computer may be a program in which processing is executed in a time-series manner according to the order described in the present specification, or may be a program in which processing is executed in parallel or at a necessary timing such as when a call is made.

Furthermore, an embodiment of the present technology is not limited to the embodiments described above, and various modifications can be made without departing from the gist of the present technology.

For example, the present technology may employ a configuration of cloud computing in which one function is shared and jointly processed by a plurality of devices via a network.

Furthermore, each step described in the flowcharts described above can be executed by one device or shared by a plurality of devices.

Moreover, in a case where a plurality of processes is included in one step, the plurality of processes included in the one step can be executed by one device or shared by a plurality of devices.

Moreover, the present technology can also employ the following configurations.

(1)

An acoustic event recognition device including:

an acquisition unit that obtains, as a feature amount of a candidate for a new acoustic event, a feature amount of an acoustic signal presented by a user or a feature amount of an acoustic signal of an environmental sound; and

a recognition unit that retains a parameter for recognizing a predetermined acoustic event, performs acoustic event recognition on the basis of the parameter and the obtained feature amount, and in a case where the predetermined acoustic event is not recognized, retains the obtained feature amount as the feature amount of the new acoustic event.

(2)

The acoustic event recognition device according to (1), in which

the recognition unit includes:

an in-label recognition unit that retains the parameter and performs the acoustic event recognition; and

a similarity/difference determination unit that retains the feature amount of the new acoustic event and performs, on the basis of the feature amount of an optional acoustic signal and the retained feature amount, similarity/difference determination about whether the optional acoustic signal is an acoustic signal of the new acoustic event.

(3)

The acoustic event recognition device according to (2), in which

the recognition unit outputs, as an acoustic event recognition result of the optional acoustic signal, a result of the acoustic event recognition performed on the optional acoustic signal by the in-label recognition unit or a result of the similarity/difference determination performed on the optional acoustic signal by the similarity/difference determination unit.

(4)

The acoustic event recognition device according to (3), in which

the similarity/difference determination unit performs the similarity/difference determination on the optional acoustic signal in a case where the predetermined acoustic event is not recognized in the acoustic event recognition performed on the optional acoustic signal by the in-label recognition unit.

(5)

The acoustic event recognition device according to any one of (2) to (4), in which

the similarity/difference determination unit includes a Siamese network.

(6)

The acoustic event recognition device according to any one of (3) to (5), further including:

a flag management unit that manages a flag indicating whether or not to output the acoustic event recognition result output from the recognition unit as a final acoustic event recognition result.

(7)

The acoustic event recognition device according to any one of (1) to (6), in which

the acquisition unit communicates with another device and obtains the feature amount of the new acoustic event candidate from the another device.

(8)

A method of recognizing an acoustic event causing an acoustic event recognition device to perform:

obtaining, as a feature amount of a candidate for a new acoustic event, a feature amount of an acoustic signal presented by a user or a feature amount of an acoustic signal of an environmental sound;

performing acoustic event recognition on the basis of a parameter for recognizing a predetermined acoustic event and the obtained feature amount; and

retaining the obtained feature amount as the feature amount of the new acoustic event in a case where the predetermined acoustic event is not recognized.

(9)

A program for causing a computer to execute a process including steps of:

obtaining, as a feature amount of a candidate for a new acoustic event, a feature amount of an acoustic signal presented by a user or a feature amount of an acoustic signal of an environmental sound;

performing acoustic event recognition on the basis of a parameter for recognizing a predetermined acoustic event and the obtained feature amount; and

retaining the obtained feature amount as the feature amount of the new acoustic event in a case where the predetermined acoustic event is not recognized.

### REFERENCE SIGNS LIST

11 Acoustic event recognition device
21 Feature amount extraction unit
22 Recognition unit
23 Flag management unit
24 Acquisition unit
25 Control unit
31 In-label recognition unit
32 Similarity/difference determination unit

1. An acoustic event recognition device comprising:
an acquisition unit that obtains, as a feature amount of a candidate for a new acoustic event, a feature amount of an acoustic signal presented by a user or a feature amount of an acoustic signal of an environmental sound; and
a recognition unit that retains a parameter for recognizing a predetermined acoustic event, performs acoustic event recognition on a basis of the parameter and the obtained feature amount, and in a case where the predetermined acoustic event is not recognized, retains the obtained feature amount as the feature amount of the new acoustic event.

2. The acoustic event recognition device according to claim 1, wherein
the recognition unit includes:
an in-label recognition unit that retains the parameter and performs the acoustic event recognition; and
a similarity/difference determination unit that retains the feature amount of the new acoustic event and performs, on a basis of the feature amount of an optional acoustic signal and the retained feature amount, similarity/difference determination about whether the optional acoustic signal is an acoustic signal of the new acoustic event.

3. The acoustic event recognition device according to claim 2, wherein
the recognition unit outputs, as an acoustic event recognition result of the optional acoustic signal, a result of the acoustic event recognition performed on the optional acoustic signal by the in-label recognition unit or a result of the similarity/difference determination performed on the optional acoustic signal by the similarity/difference determination unit.

4. The acoustic event recognition device according to claim 3, wherein
the similarity/difference determination unit performs the similarity/difference determination on the optional acoustic signal in a case where the predetermined acoustic event is not recognized in the acoustic event recognition performed on the optional acoustic signal by the in-label recognition unit.

5. The acoustic event recognition device according to claim 2, wherein
the similarity/difference determination unit includes a Siamese network.

6. The acoustic event recognition device according to claim 3, further comprising:
a flag management unit that manages a flag indicating whether or not to output the acoustic event recognition result output from the recognition unit as a final acoustic event recognition result.

7. The acoustic event recognition device according to claim 1, wherein
the acquisition unit communicates with another device and obtains the feature amount of the new acoustic event candidate from the another device.

8. A method of recognizing an acoustic event causing an acoustic event recognition device to perform:
obtaining, as a feature amount of a candidate for a new acoustic event, a feature amount of an acoustic signal presented by a user or a feature amount of an acoustic signal of an environmental sound;
performing acoustic event recognition on a basis of a parameter for recognizing a predetermined acoustic event and the obtained feature amount; and
retaining the obtained feature amount as the feature amount of the new acoustic event in a case where the predetermined acoustic event is not recognized.

9. A program for causing a computer to execute a process including steps of:
obtaining, as a feature amount of a candidate for a new acoustic event, a feature amount of an acoustic signal presented by a user or a feature amount of an acoustic signal of an environmental sound;
performing acoustic event recognition on a basis of a parameter for recognizing a predetermined acoustic event and the obtained feature amount; and
retaining the obtained feature amount as the feature amount of the new acoustic event in a case where the predetermined acoustic event is not recognized.
